(19) United States
(12) Patent Application Publication
(10) Pub. No.: US 2015/0193564 A1
(43) Pub. Date: Jul. 9, 2015

(54) SYSTEM AND METHOD FOR USING CLOCK CHAIN SIGNALS OF AN ON-CHIP CLOCK CONTROLLER TO CONTROL CROSS-DOMAIN PATHS

(71) Applicant: LSI Corporation, San Jose, CA (US)

(72) Inventors: Daryl Pereira, Assolna (IN); Deepak Agrawal, Bangalore (IN); Sanjay T. Shinde, Bangalore (IN); Sekar Manickam, Tamil Nadu (IN); Aanand Venkatachalam, Bangalore (IN)

(73) Assignee: LSI Corporation, San Jose, CA (US)

(21) Appl. No.: 14/149,059

(22) Filed: Jan. 7, 2014

(51) Int. Cl. G06F 17/50

(52) U.S. Cl. CPC G06F 17/505

(57) ABSTRACT

An on-chip clock controller configured to control cross-domain paths using clock chain signals is disclosed. The on-chip clock controller includes a clock bits module configured to receive a clock chain signal and to output an enable signal based upon the clock chain signal. The on-chip clock controller also includes a clock gating module that is communicatively coupled to the clock bits module. The clock gating module is configured to receive a clock signal and to selectively output either a signal corresponding to the clock signal or a non-transitioning signal based upon the enable signal for operating a state storage module.

### FIELD OF THE INVENTION

The present invention is directed to an on-chip clock controller, and more particularly to an on-chip clock controller configured to control cross-domain paths utilizing a clock chain signal.

### BACKGROUND

Automatic test pattern generation (ATPG) is used to identify test sequences that can be applied to circuits and/or logic to determine whether the circuits and/or logic function (e.g., behave) correctly. ATPG test patterns are utilized to test semiconductor devices after manufacturing. In some instances, ATPG test patterns are furnished to the semiconductor devices at various testing modes, such as at-speed testing and stuck-at testing. These testing modes present the test patterns at varying speeds (e.g., clock speeds) to ensure the semiconductor devices function correctly at the respective speed.

### SUMMARY

An on-chip clock controller configured to control cross-domain paths using clock chain signals is disclosed. The on-chip clock controller includes a clock bits module configured to receive a clock chain signal and to output an enable signal based upon the clock chain signal. The on-chip clock controller also includes a clock gating module that is communicatively coupled to the clock bits module. The clock gating module is configured to receive a clock signal and to selectively output either a signal corresponding to the clock signal or a non-transitioning signal based upon the enable signal for operating a state storage module.

This Summary is provided to introduce a selection of concepts in a simplified form that are further described below in the Written Description. This Summary is not intended to identify key features or essential features of the claimed subject matter, nor is it intended to be used as an aid in determining the scope of the claimed subject matter.

### BRIEF DESCRIPTION OF THE FIGURES

The Written Description is described with reference to the accompanying figures. The use of the same reference numbers in different instances in the description and the figures may indicate similar or identical items.

FIG. 1 is a block diagram of a system including multiple on-chip controller devices in accordance with an example embodiment of the present disclosure.

FIG. 2 is a diagrammatic illustration of an on-chip controller device in accordance with an example embodiment of the present disclosure.

FIG. 3 is a method diagram for controlling cross-domain paths within an on-chip controller device utilizing clock chain signals in accordance with an example embodiment of the present disclosure.

### WRITTEN DESCRIPTION

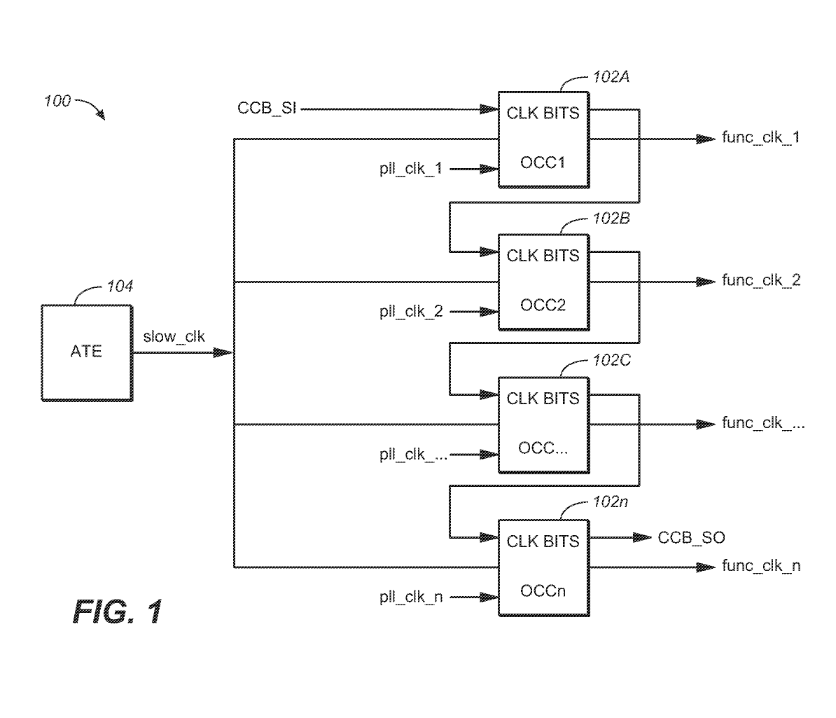

FIG. 1 shows a system 100 that includes multiple on-chip clock controller devices 102A to 102n in accordance with an example embodiment of the present disclosure. As shown, the first on-chip clock controller device 102A receives a clock chain signal (CCB_SI). This clock chain signal may be furnished to the system 100 by external automated test equipment (ATE) 104. The ATE 104 also provides an external clock signal (e.g., slow clk) to each of the on-chip clock controller devices 102A to 102n. In an embodiment of the present disclosure, the reference clock signal is utilized for stuck-at testing protocols (e.g., slow testing protocols). As described in greater detail below, each chip clock controller device 102 includes a respective clock bits module. The clock bits module associated with the first on-chip clock controller device 102A receives the clock chain signal and outputs a signal corresponding to received clock chain signal (e.g., outputs a clock chain signal). The signal corresponding to the clock chain signal is provided to the second on-chip clock controller device 102B, which is configured to output a signal corresponding to the input signal (e.g., corresponding to the clock chain signal). As shown, the respective clock bit modules output a signal corresponding to the clock chain signal input to the clock bit module. The chip clock controller devices 102A to 102n each output a respective output clock signal (e.g., func_clk_1 to func_clk_n). These clock signals are utilized to drive circuits and/or logic for the purposes of determining whether the circuits and/or logic are functioning correctly.

In one or more embodiments of the present disclosure, the system 100 utilizes clock chain signals to selectively control cross domain paths of on-chip controller devices 102. Typically, on-chip controller devices utilize top-level pins to drive flip-flops during stuck-at testing (e.g., slow testing). However, some circuitry logic may employ a number of on-chip controller devices for testing circuit functionality. Thus, these on-chip controller devices may share the same top-level clock for stuck-at mode testing, which can result in timing closure difficulties.

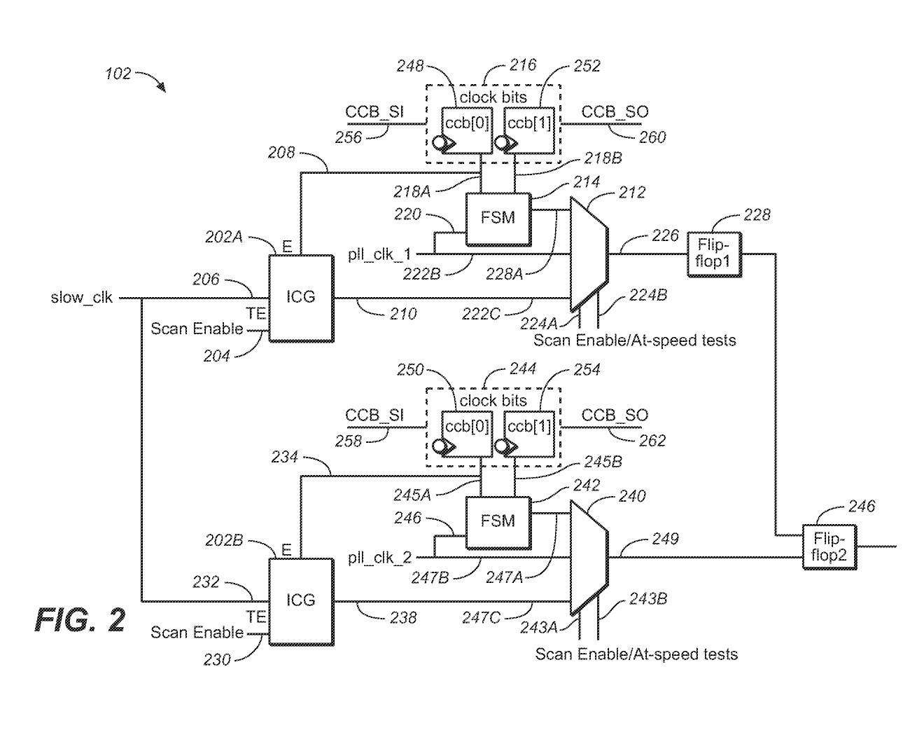

FIG. 2 shows a block diagram of an example of an on-chip clock controller device 102 in accordance with an example embodiment of the present disclosure. As shown, the clock controller device 102 includes a first clock gating module 202A and a second clock gating module 202B that are each associated with a respective domain. For example, FIG. 2 illustrates an on-chip clock controller device having two domain paths and each domain path is associated with a respective clock gating module. The clock gating modules 202A, 202B (integrated clock gating modules) are configured to provide clock gating functionality to the clock controller device 102. For example, the clock gating modules 202A, 202B are configured to selectively disable portions of the clock controller module 102 to prevent associated state storage modules (e.g., flip-flops) from switching states to at least partially mitigate timing closure issues associated with multiple paths within clock controller modules.

The first clock gating module 202A includes an input 204 for receiving a test enable signal, an input 206 for receiving a clock signal, and an input 208 for receiving an enable signal 208. In an embodiment of the present disclosure, the clock signal comprises a slow clock signal utilized by the system 100 for stuck-at testing procedures. The first clock gating device 202A also includes an output 210 and is configured to output a clock gating signal to a first multiplexer module 212 based upon the enable signal.

The clock controller device 102 also includes a first finite state machine module 214 and a first clock bits module 216. The first clock bits module 216 provides, at respective outputs 218A, 218B, clock bit signals to the first finite state machine module 214. The clock bit signals are utilized to control operation of the finite state machine module 214. The first clock bits module 216 also provides the enable signal to the first clock gating module 202A. In one or more embodiments of the present disclosure, the enable signal comprises the clock bit signal associated with output 218A. As shown, the finite state machine module 214 also receives a phase locked loop clock signal (e.g., a first phase locked loop clock signal) at input 220. The finite state machine module 214 represents sequential logic circuitry functionality that provides a finite number of states as output depending upon the input to the finite state machine module 214. The finite state machine module 214 outputs a signal to the first multiplexer 212 at input 222A

As shown in FIG. 2, the first multiplexer module 212 also receives the phase locked loop clock signal and the clock gating output signal at input 222B and input 222C, respectively. The first multiplexer module 212 is controlled by the signal provided at the two inputs 224A, 224B (e.g., data selectors). The signals at the inputs 224A, 224B select which input signal is output by the first multiplexer output at output 226. In an embodiment of the present disclosure, the signals at the inputs 224A, 224B comprise a test select signal. The test select signal indicates whether test is a stuck-at test or an at-speed test. The first multiplexer output signal is provided as input to a first flip-flop 228.

The second clock gating device 202B includes an input 230 for receiving the test enable signal, an input 232 for receiving a clock signal (e.g., a slow clock signal), and an input 234 for receiving an enable signal. The second clock gating device 202B also includes an output 238 and is configured to output a clock gating signal to a second multiplexer module 240 based upon the enable signal. The clock controller device 102 also includes a second finite state machine module 242 and a second clock bits module 244. The second clock bits module 244 provides, at respective outputs 245A, 245B, clock bit signals to the second finite state machine module 242. The second clock bits module 244 also provides the enable signal to the second clock gating module 202B. In one or more embodiments of the present disclosure, the enable signal comprises the clock bit signal associated with output 245A. The finite state machine module 242 also receives a phase locked loop clock signal (e.g., a second phase locked loop signal) at input 246. The finite state machine module 242 represents sequential logic circuitry functionality that provides a finite number of states as output depending upon the input to the finite state machine module 214. The second finite state machine module 214 is configured to generate an output signal that is provided to the second multiplexer module 240 at input 247A.

As shown in FIG. 2, the second multiplexer module 240 also receives the second phase locked loop clock signal and the second clock gating output signal at input 247B and input 247C, respectively. The second multiplexer module 240 is controlled by the signal provided at the two inputs 243A, 243B. The signals at the inputs 243A, 243B select which input signal is output by the second multiplexer output at output 249. In an embodiment of the present disclosure, the signals at the inputs 243A, 243B comprise a test select signal. The test select signal indicates whether test is a stuck-at test or an at-speed test. The first multiplexer output signal is provided as input to a second flip-flop 246.

The flip-flops 228, 246 are configured to store state information (e.g., two stable states) based upon the input signals. Thus, the first flip-flop 228 is configured to store state information based upon the output of the first multiplexer module 212. The second flip-flop 246 is configured to store state information based upon the output of the second multiplexer module 240 and the output of the first flip-flop 228. In an embodiment of the present disclosure, the flip-flops 228, 246 are edge-triggered storage modules. For example, the flip-flops 228, 246 may be positive edge-triggered. In another example, the flip-flops 228, 246 may be negative edge-triggered.

Each clock bits modules 216, 244 includes a respective first flip-flop 248, 250 and a respective second flip-flop 252, 254. As shown, the flip-flops 248, 252 of the first clock bits module 216 are electrically connected to the first finite state machine module 214, and the flip-flops 250, 254 of the clock bits module 244 are electrically connected to the second finite machine module 242. The first flip-flops 248, 250 of the respective finite state machine modules 214, 242 are electrically connected to the respective clock gating module 202A, 202B. The clock bits modules 216, 244 are configured to control the respective clock gating module 202A, 202B. For example, as described above, the clock bits modules 216, 244 furnish an enable signal (EN) to the corresponding clock gating module 202A, 202B for determining whether stuck-at testing has been performed. The clock gating modules 202A, 202B are configured to generate a clock gating output signal based upon the corresponding enable signal.

In one or more embodiments of the present disclosure, the enable signals are driven by a respective clock chain signal (CCB_SI) provided at inputs 256, 258 of the respective clock bits modules 216, 244. Each clock bits module, 216, 244 also outputs the clock chain signal (CCB_SO) at respective outputs 260, 262. This output signal may be provided to other on-chip controller modules within the system 100.

The system 100 utilizes one or more clock chain signals to control whether the flip-flop 228, 246 is driven by a transitioning signal or a substantially non-transitioning signal. During stuck-at testing, a respective clock chain signal is furnished to the clock bits module 216 and the clock bits modules 244. A first clock chain signal is furnished to the first clock bits module 216, and a second clock chain signal is furnished to the second clock bits module 244. In some embodiments of the present disclosure, the first clock chain signal is a different signal from the second clock chain signal. For example, the clock signals may differ in waveform shape, phase, or pulse duration. In some embodiments of the present disclosure, the first clock chain signal is the same signal as the second clock chain signal. The first clock chain signal and the second clock chain signal are furnished to the system 100 via suitable clock chain logic (e.g., clock chain logic circuitry).

Based upon the clock chain signals furnished to the respective clock bits module 216, 244, the output signal of the corresponding clock gating module 202A, 202B corresponds to the signal at the input 206 (e.g., reflects the clock signal). For example, when clock chain signal furnished to the clock bits module 216 (or the clock bits module 244) comprises a logic high state, the clock gating module 202A (or the clock gating module 202B) outputs a signal corresponding to the clock signal. In another example, when clock chain signal furnished to the clock bits module 216 (or the clock bits module 244) comprises a logic low state, the clock gating module 202A (or the clock gating module 202B) outputs a substantially non-transitioning signal. When the clock gating module 202A, 202B outputs a substantially non-transitioning signal, the corresponding flip-flops 228, 246 do not transition states, which may assist in reducing timing closure issues during stuck-at testing.

The system 100 is configured to work in conjunction with an automatic test pattern generation (ATPG) device (ATE 104). The ATPG device is configured to control the clock bits 248, 250 based upon the generated testing pattern. For example, the ATPG device is configured to generate test patterns that cause the output of flip-flop 248 or flip-flop 250 to be a signal having a first logic characteristic (e.g., a logic high) for a given pattern. Thus, for some patterns, the logic driven by the first multiplexer 212 at output 226 would be tested and for other test patterns, the logic driven by the second multiplexer 240 at output 249 would be tested to avoid timing conditions that create hold time violations between logic driven by the first multiplexer 212 and the second multiplexer 240. In one or more embodiments of the present disclosure, the ATPG device (e.g., ATE 104) is configured to generate test patterns to constrain the clock bits 248, 250 such that the clock bits 248, 250 do not provide a logic high signal together in the same pattern.

Some systems may also utilize hold time exceptions to overcome timing closure issues. For example, in some implementations, a system may not utilize the clock gating modules 202A, 202B. In this example, the logic driven by the first multiplexer 212 and/or the second multiplexer 240 is tested together using the same test patterns. If, for a given test pattern, the first flip-flop 228 changes states (e.g., 0->1 or 1->0), then the second flip-flop 246 is masked for the given test pattern. If, for the given test pattern, there is no change in the state of the first flip-flop 228 (0->0 or 1->1), then the second flip-flop is not masked for the given test pattern.

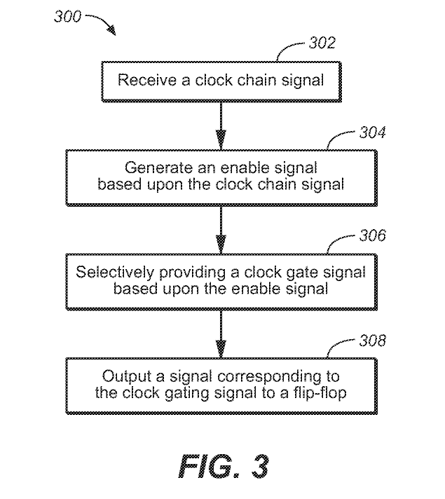

FIG. 3 illustrates an example method 300 for controlling cross-domain paths using a clock chain signal of an on-chip clock controller in accordance with an example embodiment of the present disclosure. As shown in FIG. 3, a clock chain signal is received at a clock bits module (Block 302). A clock bits module (e.g., clock bits module 216, 244) receives a clock chain signal. As described above, respective clock bits modules 216, 244 receive a corresponding clock chain signal. An enable signal is generated by the clock bits module based upon the clock chain signal (Block 304). The respective clock bits modules 216, 244 generate an enable signal based upon the clock chain signal. For example, the respective clock bits modules 216, 244 may generate an enable signal having logic high characteristics when the clock chain signal has logic high characteristics and may generate an enable signal having logic low characteristics when the clock chain signal has logic low characteristics.

A clock gating module selectively provides a clock gate signal based upon the enable signal (Block 306). In one or more embodiments of the present disclosure, the clock gating modules 202A, 202B are configured to selectively provide a clock signal (e.g., slow_clk signal) to a corresponding multiplexer module 212, 240 based upon the respective enable signal. For example, the clock gating modules 202A, 202B are configured to furnish the clock signal when the enable signal is a logic high signal and configured to furnish a substantially non-transitioning signal when the enable signal is a logic low signal. In another example, the clock gating modules 202A, 202B are configured to furnish the clock signal when the enable signal is a logic low signal and configured to furnish a substantially non-transitioning signal when the enable signal is a logic high signal.

A multiplexer module outputs a signal corresponding to the clock gating module output signal to a flip-flop (Block 308). In one or more embodiments of the present disclosure, the multiplexer modules 212, 240 output the corresponding clock gating module output signal when the respective multiplexer module 212, 240 receives input signals representing stuck-at testing. The multiplexer output signal is provided to a corresponding flip-flop 228, 246. For example, during stuck-at testing, a multiplexer module 212, 240 outputs a signal corresponding to the clock signal when the corresponding clock module 202A, 202B is outputting the clock signal or the multiplexer module 212, 240 outputs a signal corresponding to the substantially non-transitioning signal when the corresponding clock module 202A, 202B is outputting the substantially non-transitioning signal. The multiplexer output signal drives the corresponding flip-flop 228, 246. As described above, the substantially non-transitioning signal serves to at least substantially prevent the corresponding flip-flop 228, 246 from transitioning states.

As described above, the present disclosure is directed to a system 100 that utilizes clock gating modules and existing clock chain bits to control cross-domain paths. Thus, the system 100 may not require extra pins due to the utilization of existing clock chain bits. The system 100 may also have higher compression ratios as compared to systems that do not utilize clock gating modules to control cross-domain paths. Additionally, the system 100 may also restrict pattern inflation for higher compression ratios as compared to systems that do not utilize clock gating modules to control cross-domain paths as ATPG does not create unknown values. Pattern inflation increases test time, which increases test cost.

In another embodiment of the present disclosure, utilizing the clock gating modules 202A, 202B may overcome power issues. The clock gating modules 202A, 202B provides coarse control for limiting the number of flip-flops that can transition in the event of power issues. For example, in the event of allowing only fifty percent (50%) of the flip-flops within the system 100 to transition for the test patterns, allowing either the flip-flop 248 or the flip-flop 250 to output a signal having a logical characteristic (e.g., logic high) would provide environments where only fifty percent (50%) of the flip-flops are allowed to transition.

Generally, any of the functions described herein can be implemented using hardware (e.g., fixed logic circuitry such as integrated circuits), software, firmware, manual processing, or a combination of these embodiments. Thus, the blocks discussed in the above disclosure generally represent hardware (e.g., fixed logic circuitry such as integrated circuits), software, firmware, or a combination thereof. In the instance of a hardware embodiment, for instance, the various blocks discussed in the above disclosure may be implemented as integrated circuits along with other functionality. Such integrated circuits may include all of the functions of a given block, system or circuit, or a portion of the functions of the block, system or circuit. Further, elements of the blocks, systems or circuits may be implemented across multiple integrated circuits. Such integrated circuits may comprise various integrated circuits including, but not necessarily limited to: a monolithic integrated circuit, a flip chip integrated circuit, a multichip module integrated circuit, and/or a mixed signal integrated circuit. In the instance of a software embodiment, for instance, the various blocks discussed in the above disclosure represent executable instructions (e.g., program code) that perform specified tasks when executed on a processor. These executable instructions can be stored in one or more tangible computer readable media. In some such instances, the entire system, block or circuit may be implemented using its software or firmware equivalent. In other instances, one part of a given system, block or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An on-chip clock controller comprising:
a clock bits module configured to receive a clock chain signal and to output an enable signal based upon the clock chain signal; and
a clock gating module communicatively coupled to the clock bits module, the clock gating module configured to receive a clock signal and to selectively output at least one of a signal corresponding to the clock signal or a substantially non-transitioning signal based upon the enable signal for operating a state storage module configured to store state information.

2. The on-chip clock controller as recited in claim 1, further comprising the state storage module communicatively coupled to the clock gating module, wherein the signal corresponding to the clock signal causes the state storage module to transition states and the substantially non-transitioning signal at least substantially prevents the state storage module from transitioning states.

3. The on-chip clock controller as recited in claim 1, further comprising a multiplexer module communicatively coupled to the clock gating module and to the state storage module, the multiplexer module configured to output the at least one of the signal corresponding to the clock signal or a substantially non-transitioning signal to the state storage module when a stuck-at testing input is furnished to the multiplexer module.

4. The on-chip controller as recited in claim 1, further comprising a second clock bits module configured to receive a second clock chain signal and to output an enable signal based upon the second clock chain signal;
a second clock gating module communicatively coupled to the second clock bits module, the second clock gating module configured to receive the clock signal and to selectively output at least one of a signal corresponding to the clock signal or a substantially second non-transitioning signal based upon the enable signal for operating a second state storage module.

5. The on-chip clock controller as recited in claim 1, further comprising the second state storage module communicatively coupled to the second clock gating module and to the state storage module, wherein the signal corresponding to the clock signal causes the second state storage module to transition states and the substantially non-transitioning signal at least substantially prevents the second state storage module from transitioning states.

6. The on-chip clock controller as recited in claim 4, wherein at least one of the state storage module or the second state storage module comprises a flip-flop.

7. The on-chip clock controller as recited in claim 1, wherein the state storage module comprises a flip-flop.

8. The on-chip clock controller as recited in claim 1, wherein the clock bits module includes a first flip-flop and a second flip-flop.

9. A system comprising:
a plurality of on-chip clock controllers configured to receive a clock chain signal, each on-chip clock controller comprising:
a clock bits module configured to receive the clock chain signal and to output an enable signal based upon the clock chain signal; and
a clock gating module communicatively coupled to the clock bits module, the clock gating module configured to receive a clock signal and to selectively output at least one of a signal corresponding to the clock signal or a substantially non-transitioning signal based upon the enable signal for operating a state storage module configured to store state information.

10. The system as recited in claim 9, further comprising the state storage module communicatively coupled to the clock gating module, wherein the signal corresponding to the clock signal causes the state storage module to transition states and the substantially non-transitioning signal at least substantially prevents the state storage module from transitioning states.

11. The system as recited in claim 9, further comprising a multiplexer module communicatively coupled to the clock gating module and to the state storage module, the multiplexer module configured to output the at least one of the signal corresponding to the clock signal or a substantially non-transitioning signal to the state storage module when a stuck-at testing input is furnished to the multiplexer module.

12. The system as recited in claim 9, further comprising a second clock bits module configured to receive a second clock chain signal and to output an enable signal based upon the second clock chain signal;
a second clock gating module communicatively coupled to the second clock bits module, the second clock gating module configured to receive the clock signal and to selectively output at least one of a signal corresponding to the clock signal or a substantially second non-transitioning signal based upon the enable signal for operating a second state storage module.

13. The system as recited in claim 9, further comprising the second state storage module communicatively coupled to the second clock gating module and to the state storage module, wherein the signal corresponding to the clock signal causes the second state storage module to transition states and the substantially non-transitioning signal at least substantially prevents the second state storage module from transitioning states.

14. The system as recited in claim 13, wherein at least one of the state storage module or the second state storage module comprises a flip-flop.

15. The system as recited in claim 9, wherein the state storage module comprises a flip-flop.

16. The system as recited in claim 9, wherein the clock bits module includes a first flip-flop and a second flip-flop.

17. A method comprising:
receiving a clock chain signal from a clock bits module;
generating an enable signal based upon the clock chain signal; and
selectively providing a clock gate signal from a clock gating module based upon the enable signal, the clock gate signal comprising a signal corresponding to a clock signal when the enable signal comprises a first logic characteristic and the clock gate signal comprising a substantially non-transitioning signal when the enable signal comprises a second logic characteristic, the second logic characteristic different from the first logic characteristic,
wherein the clock gate signal operates a state storage module.

18. The method as recited in claim 17, wherein the clock bits module generates a clock chain signal based upon a test pattern generated by an automatic test pattern generation device.

19. The method as recited in claim 17, wherein the clock bits module includes a first flip-flop and a second flip-flop.

20. The method as recited in claim 17, wherein the first logic characteristic comprises a logic high characteristic and the second logic characteristic comprises a logic low characteristic.
